(19) United States
(12) Patent Application Publication
(10) Pub. No.: US 2026/0311460 A1
(43) Pub. Date: Oct. 8, 2026

(54) MODEL TRAINING METHOD, INSTANCE SEGMENTATION METHOD AND DEVICE, EQUIPMENT AND MEDIUM

(71) Applicant: Beijing Youzhuju Network Technology Co., Ltd., Beijing (CN)

(72) Inventors: Minzhao ZHU, Beijing (CN); Leyao LIU, Beijing (CN); Tao KONG, Beijing (CN)

(21) Appl. No.: 18/996,853

(22) PCT Filed: Jul. 17, 2023
(86) PCT No.: PCT/CN2023/107725

§ 371 Date: Jan. 17, 2025

(30) Foreign Application Priority Data
Jul. 18, 2022 (CN) 202210843130.6

(51) Int. Cl. G06V 10/774; G06V 10/762; G06V 10/82

(52) U.S. Cl. CPC G06V 10/774; G06V 10/762; G06V 10/82

(57) ABSTRACT

Embodiments of the disclosure relate to a model training method, an instance segmentation method, apparatus, device and a medium. The model training method includes: obtaining a sample image; obtaining an initial label of the sample image, wherein the initial label includes a semantic category and an instance category to which a target point belongs, and the target point labeled by the object is a point in the object; generating an extended label of the sample image based on the initial label, wherein the extended label includes a semantic category and an instance category to which an association point of the target point belongs; and training an initial neural network model based on the initial label and the extended label, and determining the neural network model at the end of training as an instance segmentation model.

This application claims priority to Chinese Patent Application No. 202210843130.6, filed on Jul. 18, 2022, entitled “Model Training Method, Instance Segmentation Method, Apparatus, Apparatus, and Medium”.

### FIELD

The present disclosure relates to the technical field of artificial intelligence, in particular to a model training method, an instance segmentation method and device, equipment and a medium.

### BACKGROUND

An instance segmentation task is an important task in computer vision, a semantic category and an instance category to which each point in the image belongs may be predicted, that is, various object categories included in the image may be indicated and different instance object may be further distinguished. The existing instance segmentation model for executing the instance segmentation task needs to label a large number of points in the training sample image during training, that is, very dense labeling information is required, and the required labeling cost is very high.

### SUMMARY

To resolve the foregoing technical problems or at least partially solve the foregoing technical problems, the present disclosure provides a model training method, an instance segmentation method, apparatus, device, and a medium.

Embodiment of the present disclosure provide a model training method, and the method comprises: obtaining a sample image; obtaining an initial label of the sample image, wherein the initial label comprises a semantic category and an instance category to which a target point belongs, each object in the sample image is labeled with one target point, and the target point labeled by the object is a point in the object; generating an extended label of the sample image based on the initial label, wherein the extended label comprises a semantic category and an instance category to which the association point of the target point belongs, and the semantic category and the instance category to which the association point belongs are determined based on the semantic category and the instance category to which the target point belongs; training an initial neural network model based on the initial label and the extended label, and determining the neural network model at the end of training as an instance segmentation model.

Embodiments of the present disclosure further provide an instance segmentation method, comprising: obtaining a target image; inputting the target image into a pre-trained instance segmentation model, wherein the instance segmentation model is obtained by adopting the model training method; obtaining an instance segmentation result output from the instance segmentation model; the instance segmentation result comprising a semantic category and an instance category to which each point in the target image belongs.

Embodiments of the present disclosure further provide an apparatus for model training apparatus, comprising: a sample obtaining module configured to obtain a sample image; an initial label obtaining module configured to obtain an initial label of the sample image, wherein the initial label comprises a semantic category and an instance category to which a target point belongs, each object in the sample image is labeled with one target point, and the target point labeled by the object is a point included in the object; an extended label generation module configured to generate an extended label of the sample image based on the initial label, wherein the extended label comprises a semantic category and an instance category to which an association point of the target point belongs, and a semantic category and an instance category to which the association point belongs are determined based on a semantic category and an instance category to which the target point belongs; and a model training module configured to train an initial neural network model based on the initial label and the extended label, and determine the neural network model at the end of training as an instance segmentation model.

Embodiments of the present disclosure further provide an apparatus for instance segmentation, comprising: an image obtaining module configured to obtain a target image; a model input module configured to input the target image to a pre-trained instance segmentation model, wherein the instance segmentation model is obtained by using any of the model training methods; and a result obtaining module configured to obtain an instance segmentation result output from the instance segmentation model, wherein the instance segmentation result comprises a semantic category and an instance category to which each point in the target image belongs.

Embodiments of the present disclosure further provide an electronic device, comprising: a processor; a memory for storing executable instructions by the processor; and the processor configured to read the executable instructions from the memory and executes the instructions to implement the model training method or the instance segmentation method provided in embodiments of the present disclosure.

Embodiments of the present disclosure further provide a computer-readable storage medium, where the storage medium stores a computer program, and the computer program is configured to perform the model training method or the instance segmentation method provided in embodiments of the present disclosure.

According to technical solutions provided in embodiments of the present disclosure, during the model training, only one target point may be separately labeled for each object in the sample image, and then expansion may be performed based on the initial label (the semantic category and the instance category to which the target point belongs) to obtain the extended label (the semantic category and the instance category to which the association point of the target point belongs), so that the model training is performed based on the initial label and the extended label, to obtain the instance segmentation model and perform subsequent instance segmentations. According to the above method, only one point needs to be marked for each object, and the marking cost is greatly saved. Moreover, since the marking cost required by the instance segmentation model adopted by the instance segmentation method is relatively low, that is, obtaining the instance segmentation model is more convenient, the universality of the instance segmentation method is also improved.

It should be understood that the content described in this section is not intended to identify key or important features of the embodiments of the present disclosure, nor is it intended to limit the scope of the present disclosure. Other features of the present disclosure will become readily understood from the following description.

### BRIEF DESCRIPTION OF DRAWINGS

The drawings herein are incorporated in and constitute a part of this specification, illustrating embodiments consistent with the present disclosure and, together with the description, serve to explain the principles of the present disclosure.

In order to more clearly illustrate the technical solutions in embodiments of the present disclosure or in the prior art, the accompanying drawings used in the description of embodiments or the prior art will be briefly introduced below, and it is obvious to those skilled in the art that other drawings may be obtained according to these drawings without creative efforts.

FIG. 1 is a schematic flowchart of a method for model training according to an embodiment of the present disclosure;

FIG. 2 is a schematic diagram of model training according to an embodiment of the present disclosure;

FIG. 3 is a schematic flowchart of a method for instance segmentation according to an embodiment of the present disclosure;

FIG. 4 is a schematic structural diagram of an apparatus for model training according to an embodiment of the present disclosure;

FIG. 5 is a schematic structural diagram of an apparatus for instance segmentation according to an embodiment of the present disclosure; and

FIG. 6 is a schematic structural diagram of an electronic device according to an embodiment of the present disclosure.

### DETAILED DESCRIPTION

In order to be able to more clearly understand the above objects, features and advantages of the present disclosure, solutions of the present disclosure will be further described below. It should be noted that, in the case of no conflict, the features in the embodiments and embodiments of the present disclosure may be combined with each other.

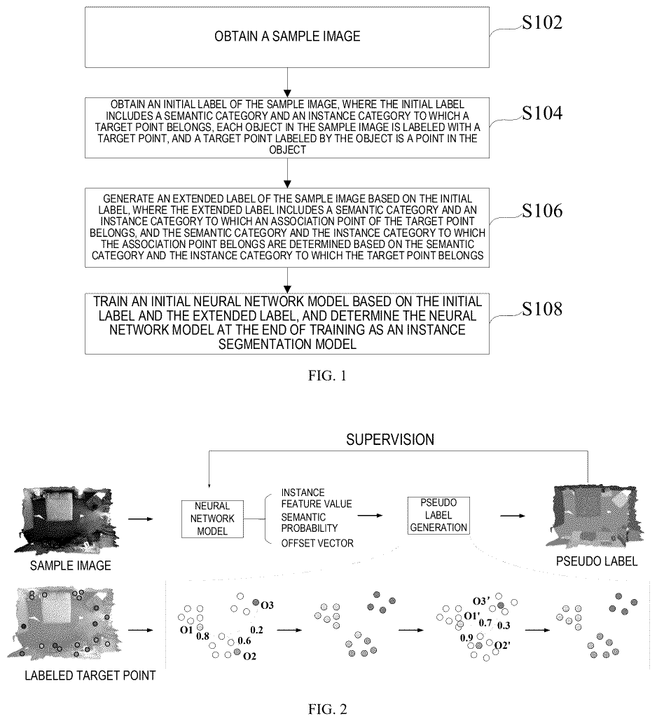

FIG. 1 is a schematic flowchart of a model training method according to an embodiment of the present disclosure. The method may be performed by an apparatus for model training, and the apparatus may be implemented in a software and/or hardware which may be generally integrated in an electronic device. As shown in FIG. 1, the method mainly includes the following steps S102 to S108.

Step S102: obtaining a sample image.

The sample image may be a two-dimensional image (a 2D plane image) or a three-dimensional image (such as a three-dimensional point cloud), and the form of the sample image is not limited in embodiments of the present disclosure. In practical applications, there are usually a plurality of sample images, and each sample image includes at least one object. The object may be a person, an animal, a plant, a stationary object, or a dynamic object such as a vehicle. It should be noted that, for example, the sky, the ground, and the like may also be regarded as objects, and the type/quantity of objects included in the sample image is not limited in embodiments of the present disclosure.

Step S104: obtaining an initial label of the sample image, where the initial label includes a semantic category and an instance category to which a target point belongs. Each object in the sample image is labeled with one target point, and the target point labeled by the object is a point in the object.

The initial label is a label obtained by labeling the sample image initially. In this embodiment of the present disclosure, only one point needs to be labeled for each object in the sample image. A point marked on the object is the target point. The target point may be any point in the object, or may be a point of a center point of the object or other key positions of the object, which is not limited herein. In practical applications, a semantic category and an instance category to which a point on each object belongs may be pre-labeled, so as to obtain an initial label conveniently and quickly. The semantic category may be understood as an object category, for example, the semantic category to which the target point belongs may indicate that the category of the object to which the target point belongs is a person, a cat, a dog, a vehicle and the like. The category of the instance to which the target point belongs may be understood as further indicating which object the target point belongs to on the basis of the semantic category. For example, when there are a plurality of persons in the sample image, the semantic category only indicates that the target point belongs to the person, and the instance category may further distinguish the plurality of persons to indicate which person the target point specifically belongs to.

In the embodiment of the present disclosure, only the information of one point needs to be marked for each object. It is assumed that there are N objects in the sample image, then each object is marked with one point, and finally only N points (target points) need to be marked, compared with the fact that a very dense point needs to be manually marked on the sample image in the related art, the method only needs to mark one point for each object is very convenient and fast, and the implementation is easy.

Step S106: generating an extended label of the sample image based on the initial label, where the extended label includes a semantic category and an instance category to which an association point of the target point belongs, and the semantic category and the instance category to which the association point belongs are determined based on a semantic category and an instance category to which the target point belongs.

Since only one point is initially marked for each object, the number of the obtained initial labels is small, so that the model can be trained normally, and therefore the extended label can be automatically generated based on the initial label. Specifically, the association point of the target point may be found, and the association point of the target point is a point having a certain correlation with the target point, such as a point having a same feature (such as a color and the like) with the target point and/or a point located in a specified distance range of the target point. Based on the semantic category and the instance category to which the target point belongs, the semantic category and the instance category to which the association point of the target point belongs may be further expanded. For example, the semantic category and the instance category to which the association point belongs are consistent with the semantic category and the instance category to which the target point belongs. By means of the mode, the number of the labels can be quickly and effectively expanded, and the accuracy of the extended labels is ensured to a certain extent.

Step S108, training an initial neural network model based on the initial label and the extended label, and determining the neural network model at the end of the training as an instance segmentation model.

It may be understood that the process of training the neural network model is substantially the process of adjusting the network parameters of the neural network model until a preset condition (such as a loss function convergence, and the neural network model may output an expected instance segmentation result) is met, and the training ends. The embodiments of the present disclosure do not limit the model structure, for example, may be a convolutional neural network or another network structure, and any network structure that may be used as an instance segmentation may be used. In embodiments of the present disclosure, only a very small amount of annotation information is required, and then model training may be performed on this basis, which may also be referred to as weak supervision training. In a specific training process, a pseudo label may be further generated based on an output result of the neural network model for self-training, so as to further improve model training accuracy.

According to technical solutions provided in the embodiments of the present disclosure, during the model training, only one target point may be separately labeled for each object in the sample image. Expansion may be then performed based on the initial label (the semantic category and the instance category to which the target point belongs) to obtain the extended label (the semantic category and the instance category to which the association point of the target point belongs), so that the model training is performed based on the initial label and the extended label, to obtain the instance segmentation model and perform subsequent instance segmentation. According to the method, only one point needs to be marked for each object, and the marking cost is greatly saved.

In some implementations, the step of generating the extended label of the sample image based on the initial label may be implemented with reference to the following step a to step c:

Step a: obtaining a low-level feature of the sample image. By way of example, when the sample image is a two-dimensional plane image, the low-level feature may include, for example, a color feature. When the sample image is a three-dimensional point cloud, the low-level feature may include a color feature, a normal vector feature, and the like. In addition, the low-level feature may further include a texture feature, a shape feature, and the like, which is not limited herein.

Step b: performing a segmentation processing on the sample image based on the low-level feature, and obtaining the association point of the target point based on a segmentation result. For example, if the sample image is divided into a plurality of local units according to the low-level feature, a point located at the same local unit as the target point is used as the association point of the target point. In order to find the association point of the target point relatively quickly and accurately, the sample image is segmented according to the low-level feature, and the step of obtaining the association point of the target point based on the segmentation result includes at least one of the following (1) and (2):

When the sample image is a two-dimensional image, superpixel segmentation processing is performed on the sample image based on the low-level feature, and an association point of the target point is obtained based on the segmentation result.

For example, the two-dimensional image may be subdivided into a plurality of local units according to low-level features such as color, brightness, texture and the like. Each local unit may be regarded as a super-pixel, the super-pixel is a small area composed of a series of pixels adjacent to and similar to the low-level feature. Most of these small areas retain valid information for further image segmentation, and generally do not damage boundary information of the object in the image. Specifically, a super-pixel segmentation algorithm may be used to perform the segmentation processing on the sample image, to obtain the association point of the target point based on the segmentation result. In a specific implementation example, a point in the sample image that belongs to a same superpixel as the target point may be used as the association point of the target point. Specifically, the superpixel segmentation result includes a plurality of superpixels, each superpixel may include a plurality of points that are similar to and adjacent to the plurality of features. For each target point, the remaining points that belong to one superpixel to which the target point belongs may be used as the association points of the target point, or some points (such as the points adjacent to the target point in the superpixel) that belong to the same superpixel as the target point may be used as the association points of the target point, which is not limited herein.

(2) When the sample image is a three-dimensional image, supervoxel segmentation processing is performed on the sample image according to the low-level feature, and the association point of the target point is obtained based on the segmentation result.

When the sample image is a three-dimensional image, point cloud data representation may be used, that is, supervoxel segmentation processing may be performed on the point cloud according to low-level features such as color and normal vector, and a plurality of local units of the point cloud may also be obtained, and each local unit may be considered as a super-voxel. An voxel is a small area composed of points in the point cloud that are adjacent to each other and have similar low-level features. Specifically, a supervoxel segmentation algorithm may be used to perform the segmentation processing on the sample image, to obtain the association point of the target point based on the segmentation result. In a specific implementation example, a point in the sample image that is the same as the target point and that belongs to one super-voxel may be used as an association point of the target point. Specifically, the superpixel segmentation result includes a plurality of supervoxels, each supervoxel may include a plurality of points that are similar in feature and are adjacent to each other. For each target point, the remaining points that belong to a same supervoxel as the target point may be used as the association points of the target point, or some points in the remaining points that belong to one super voxel as the target point (such as a point adjacent to the target point in the super-voxel) may be used as the association points of the target point, which is not limited herein.

Step c, obtaining the extended label of the sample image by respectively determining the semantic category and the instance category to which the target point belongs as the semantic category and the instance category to which the association point belongs to.

Since the association point is similar to the low-level feature of the target point and the association point is usually adjacent to the target point, probability that the association point and the target point belong to the same object is extremely large, so that the semantic category and the instance category to which the target point belongs can be determined as the semantic category and the instance category to which the association point belongs respectively, and a relatively reliable and accurate extended label can be obtained at the beginning in the manner provided in the foregoing steps a to c, so that initial training of the model can be performed subsequently by using relatively large numbers of labels.

In some implementations, training the preset neural network model based on the initial label and the extended label, and determining the neural network model at the end of training as the instance segmentation model may be implemented with reference to the following steps 1 to 3.

Step 1: performing a first training on the initial neural network model based on the initial label and the extended label, and determining the neural network model that reaches a first training end condition as a first neural network model. The first training end condition may include one or more of the following: the total loss function value converging to a first preset threshold, reaching a first training number threshold, or reaching a first training duration threshold. The total loss function value is determined based on the label and the model output result.

In actual implementation, the sample image may be input into the neural network model to obtain a segmentation result output by the neural network model for the sample image. The segmentation result is evaluated based on the label (the initial label and the extended label) and a preset loss function to obtain a total loss function value. In some specific implementation examples, the segmentation result output by the neural network model during training may be represented by using only information such as an instance feature value, a semantic probability, and an offset vector of each point in the sample image, where the semantic probability may be directly used for semantic segmentation, and the instance feature value and the offset vector may be used to perform instance segmentation. Then, the segmentation result is evaluated based on the label (the initial label and the extended label). For example, a first loss value corresponding to the instance feature value is determined based on a label and a discriminative loss function, a second loss value corresponding to the semantic probability is determined based on the label and the cross entropy loss function, a third loss value corresponding to the offset vector is determined based on the L2 loss function. The first loss value, the second loss value, and the third loss value are weighted and summed to obtain a total loss value (that is, the abbreviation of the total loss function value), and the parameter of the neural network model is adjusted based on the total loss value until the first training end condition is reached. At this time, a preliminary trained first neural network model may be obtained, and the first neural network model has a certain instance segmentation capability.

Step 2: obtaining an output result of the first neural network model for each to-be-measured point in the sample image and generating a pseudo label based on the output result. The pseudo label includes a semantic category and an instance category to which each point in the sample image belongs. In practical applications, each point in the sample image may be used as a to-be-measured point, or a part of points in the sample image may be used as a to-be-measured point, and some points in the sample image may be a plurality of randomly determined points, or may be a plurality of specified points. For example, a preset quantity of points in the sample image may be randomly determined as the to-be-measured point, or a plurality of points distributed at different positions in the sample image may be specified as the to-be-measured point according to requirements. If the to-be-measured points are only part of points in the sample image, the quantity threshold may be further set, so that the quantity of to-be-measured points needs to be higher than a preset quantity threshold, thereby ensuring reliability of model training.

The output result includes an instance feature value, a semantic probability, and an offset vector. On this basis, when generating the pseudo label based on the output result, the pseudo label may be generated based on the instance feature value, the semantic probability and the offset vector of each point to be measured in the sample image, and the semantic category and the instance category to which the target point belongs. It can be understood that the pseudo label is not an artificially actually marker label, but the prediction result of the model for the unlabeled data in the training process is not necessarily accurate, and therefore may be referred to as a pseudo label (or pseudo label). However, the pseudo label may help the model learn information hidden in the unlabeled data, and by applying the pseudo label generated by the model to the model training process for supervision, the weakly supervised learning effect based on the self-training may be more reliably achieved. In the embodiment of the present disclosure, the instance feature value, the semantic probability and the offset vector of each to-be-measured point in the sample image output based on the neural network model are clustering according to a clustering algorithm, the semantic category and the instance category to which each to-be-measured point belongs can be conveniently obtained according to the clustering result and the semantic category and the instance category to which the known target point belongs, and the generated pseudo-label is relatively accurate. In addition, the embodiments of the present disclosure may not limit the clustering algorithm, including but not limited to a K-means clustering algorithm (K-means clustering), and the like.

For ease of understanding, an embodiment of the present disclosure further provides a specific implementation of generating a pseudo label by using a preset clustering algorithm, and for example, reference may be made to the following steps A to B:

Step A: by taking the target point as an initial cluster center in a predetermined clustering algorithm, performing a clustering processing based on the initial cluster center and the instance feature value, the semantic probability and the offset vector of each of the to-be-measured points in the sample image.

The cluster center may also be referred to as a seed, the initial cluster center may also be referred to as an initial seed. The target point may be initially used as an initial cluster center, and then a plurality of iterative clustering is performed until the cluster center no longer changes. Specifically, reference may be made to the following implementation:

During an initial clustering process, a first similarity (also referred to as a first distance) between each of the to-be-measured points and the initial cluster center is obtained based on the instance feature value, the semantic probability and the offset vector of each of the to-be-measured points in the sample image, and a new cluster center is determined based on the first similarity. Specifically, category division may be performed according to the first similarity corresponding to each of the to-be-measured points and each initial cluster center, each of the to-be-measured points is classified into a category to which the cluster center closest to the to-be-measured point belongs, and then the position of each cluster center is recalculated based on the preliminarily obtained category cluster (such as averaging all points in each category, and the like). During non-initial clustering processing, based on the instance feature value, the semantic probability and the offset vector of each of the to-be-measured points in the sample image, a second similarity (which may also be referred to as a second distance) between each of the to-be-measured points and a cluster center obtained by the previous clustering processing is obtained, and a new cluster center is determined according to the second similarity (referring to the foregoing specific implementation of determining the new cluster center). The clustering is stopped when the cluster center does not change any more. The number of the cluster centers is equal to the number of the target points, that is, equal to the number of the objects in the sample images. The similarity may also be referred to as a distance in a clustering algorithm. Through the multi-iteration processing, the cluster center is repeatedly adjusted, and finally, clustering is stopped when the cluster center no longer changes, so that a relatively accurate clustering result can be obtained. Moreover, according to embodiment of the present disclosure, the target points marked on each object are used as initial cluster centers, different target points correspond to different objects, so that the clustering efficiency is improved, the final cluster center can be found within a few iterations, the calculation overhead can be effectively saved, and the problem that more calculation expenditure is caused by initially selecting an inappropriate initial cluster center is well avoided. In addition, the reliability of the clustering result can be guaranteed to a certain extent, and finally each cluster can correspond to one object more accurately.

Step B: obtaining a semantic category and an instance category to which each of the to-be-measured points in the sample image belongs based on the clustering result and the semantic category and the instance category to which the target point belongs.

In some specific implementation examples, the same cluster point of the target points may be obtained according to the clustering result. It may be understood that the clustering result includes a plurality of clusters, the same cluster points are to-be-measured points in the sample image that belong to a same cluster as the target point, and the clusters in the clustering result are in a one-to-one correspondence with the object in the sample image (that is, the objects corresponding to different clusters are different). In other words, the remaining to-be-measured points that belong to the same object as each target point may be found through the foregoing clustering result, and then the semantic category and the instance category to which the target point belongs may be directly used as the semantic category and the instance category of the same cluster point. It can be understood that each point to be measured in the sample image has an object to which it belongs, and each object has been labeled with a target point, so each point to be measured corresponds to a target point belonging to the same object. For each object, the cluster of the object is obtained through the above clustering method, and the semantic category and the instance category of the target point in the cluster corresponding to the object are known, and the semantic category and the instance category of the remaining to-be-measured points are theoretically consistent with the semantic category and the instance category of the target point, and at this time, the semantic category and the instance category of the remaining to-be-measured points in the object can be directly determined according to the semantic category and the instance category of the target point in the object.

Through the above steps A and B, the target point is used as the initial cluster center, so that the clustering efficiency can be effectively improved, the calculation overhead required for clustering is saved, the reliability of the clustering result is ensured. On this basis, the remaining to-be-measured points of the same object as the target point can be found more accurately through a clustering mode, and the semantic category and the instance category of the target point in each object are directly used as the semantic category and the instance category of the remaining to-be-measured points in the object, so that each unlabeled to-be-detected point can be efficiently and accurately labeled, and the pseudo label output by the model is obtained.

Step 3: performing a second training on the first neural network model based on the pseudo label, and determining the first neural network model that reaches a second training end condition as an instance segmentation model.

The process of performing the second training on the first neural network model based on the pseudo label is similar to the process of performing the first training on the initial neural network model based on the initial label and the extended label. The difference is that the first training is the initial training, the initial label and the label obtained based on the initial label expansion are used, the second training is a model self-training, and the pseudo label obtained by the output result of the first neural network model that is preliminarily trained is used, i.e., the labels used for training are different. The second training end condition may include one or more of the following: a total loss function value converging to a second preset threshold, reaching a second training number threshold, or reaching a second training duration threshold. The foregoing calculation manner of the total loss function value also refers to a manner in which the total loss function value is calculated in the first training process, for example, weighted summation is performed on the first loss value corresponding to the instance feature value, the second loss value corresponding to the semantic probability, and the third loss value corresponding to the offset vector to obtain the total loss function value, and details are not described herein again. In addition, it should be noted that both the first training and the second training represent a training phase, and do not represent the number of training times, whether the first training or the second training is performed multiple times (that is, the model parameter are adjusted multiple times in a backward propagation manner), and each training outputs a pseudo label, and the output pseudo label is used to supervise the output result of the model during the next training, so as to adjust the model parameters until the preset training end condition is reached.

Through the above steps 1 to 3, the neural network model is initially trained by adopting the initial label and the extended label, after the neural network model has certain instance segmentation capability, the pseudo label is generated based on the output result of the neural network model, the neural network model is self-trained by adopting the pseudo label. The above embodiments only need to label one point for each object, the subsequent label can be automatically generated based on the initial marked point, the labeling cost is greatly reduced, the method for obtaining the extended label based on the low level feature or obtaining the pseudo label based on the clustering mode is relatively reliable, the accuracy of the label for training the model can be effectively ensured, and the model precision obtained by training is guaranteed to a certain extent.

For ease of understanding, reference may be made to the schematic diagram of model training shown in FIG. 2. In this schematic diagram, the sample image is input to the neural network model, the neural network model may respectively output an instance feature value, a semantic probability and an offset vector for each point in the sample image, and may generate a pseudo label based on the output result. The pseudo label includes a semantic category and an instance category to which each point in the sample image belongs, where the semantic category is obtained based on a semantic probability, and the instance category is obtained based on the instance feature value and the offset vector. The pseudo label may be then used to supervise the neural network model, thereby adjusting parameters of the neural network model. In FIG. 2, it is shown that only one target point needs to be labeled for each object, and meanwhile, a manner of generating a pseudo label based on the output result of the model is illustrated. Specifically, clustering processing may be performed by using a clustering algorithm based on the instance feature value, the semantic probability and the offset vector of each point output by the model for the sample image, where the target points are initial clusters center which are represented as O1, O2, and O3 (represented by solid circles of different gray scales) respectively. Taking a random point as an example, a similarity between the point and the O1 is 0.8, a similarity between the point and the O2 is 0.6, and a similarity between the point and the O3 is 0.2. After calculating the similarity between each point and the O1, the O2, and the O3, the similarity between each point and the O1, the O2, and the O3 may be reclustered, and the gray scales corresponding to different clusters are different. Then, the cluster centers O1′, O2′, O3′ (represented by solid circles of different gray scales) of the new class clusters are found. Similarities between each point and the new cluster center O1′, O2′, O3′ are calculated again. Re-clustering is performed based on the similarities. Finally, a cluster of which cluster center is no longer changed is obtained after multiple clustering, and each cluster corresponds to one object, so as to obtain the semantic category and the instance category of each point based on the semantic category and the instance category of the target point in the cluster to which each point belongs, so as to generate the pseudo label more conveniently and reliably. It should be further noted that FIG. 2 is merely a simple example, and all clusters/all points are not illustrated.

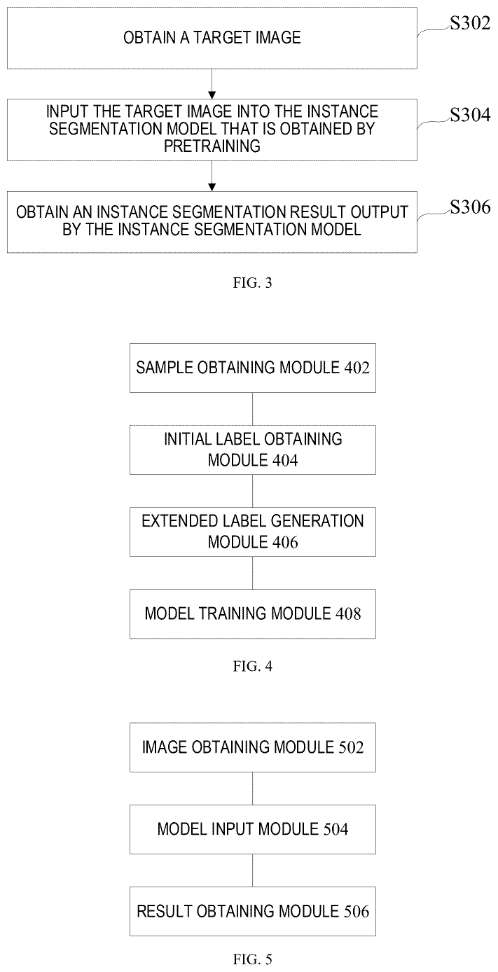

Based on the foregoing, an embodiment of the present disclosure provides an instance segmentation method, referring to a schematic flowchart of an instance segmentation method shown in FIG. 3, and mainly includes the following steps S302 to S306:

Step S302: obtaining a target image. The target image is an image to be instance segmented.

Step S304, inputting the target image into a pre-trained instance segmentation model, where the instance segmentation model is obtained by using any of the foregoing model training methods, and the specific training manner may refer to the foregoing related contents, which is not limited herein.

Step S306: obtaining an instance segmentation result output from the instance segmentation model, where the instance segmentation result includes a semantic category and an instance category to which each point in the target image belongs. During implementations, the instance segmentation model may output an instance feature value, a semantic probability and an offset vector corresponding to each point for the target image, obtain a semantic category to which each point belongs based on the semantic probability, and calculate a similarity between different points based on the instance feature value and the semantic probability, so as to obtain the instance category to which each point belongs by means of a Mean-shift clustering manner.

Since the labeling cost required by the instance segmentation model adopted by the instance segmentation method is relatively low, that is, obtaining the instance segmentation model is more convenient, the universality of the instance segmentation method is also improved. Further, based on the foregoing manner, whether the extended label is obtained based on the low-level feature or the manner in which the pseudo-label is obtained based on the clustering manner is relatively reliable. Compared with a conventional weakly supervised training manner, the foregoing manner provided in embodiments of the present disclosure can effectively ensure accuracy of labels used to train the model, so that the accuracy of the trained instance segmentation model is relatively high, that is, only very few pieces of label information are required in the of the present disclosure to achieve higher segmentation precision.

Corresponding to the foregoing model training method, an embodiment of the present disclosure provides a schematic structural diagram of an apparatus for model training, and FIG. 4 is a schematic structural diagram of a model training apparatus according to an embodiment of the present disclosure. The apparatus may be implemented in software and/or hardware which is generally integrated in the electronic device. As shown in FIG. 4, the apparatus includes:
a sample obtaining module 402 configured to obtain a sample image;
an initial label obtaining module 404 configured to obtain an initial label of the sample image, where the initial label comprises a semantic category and an instance category to which a target point belongs, each object in the sample image is labeled with one target point, and the target point labeled by the object is a point in the object;
an extended label generation module 406 configured to generate an extended label of the sample image based on the initial label, where the extended label includes a semantic category and an instance category to which an association point of the target point belongs, and the semantic category and the instance category to which the association point belongs are determined based on a semantic category and an instance category to which the target point belongs.
a model training module 408 configured to train an initial neural network model based on the initial label and the extended label, and determine the neural network model at the end of training as an instance segmentation model.

According to technical solutions provided in embodiments of the present disclosure, during the model training, only one target point may be separately labeled for each object in the sample image, and then expansion may be performed based on the initial label (the semantic category and the instance category to which the target point belongs) to obtain the extended label (the semantic category and the instance category to which the association point of the target point belongs), so that the model training is performed based on the initial label and the extended label, to obtain the instance segmentation model and perform subsequent instance segmentation. According to the method, only one point needs to be marked for each object, and the labeling cost is greatly saved.

In some implementations, the extended label generation module 406 is specifically configured to: obtain a low-level feature of the sample image; perform a segmentation processing on the sample image according to the low-level feature, and obtain the association point of the target point based on a segmentation result; and obtain the extended label of the sample image by determining the semantic category and the instance category to which the target point belongs as the semantic category and the instance category to which the association point belongs to.

In some implementations, the extended label generation module 406 is specifically configured to at least one of the following: in response to that the sample image is a two-dimensional image, perform a superpixel segmentation processing on the sample image according to the low-level feature, and obtain an association point of the target point based on a segmentation result; and in response to that the sample image is a three-dimensional image, perform a supervoxel segmentation processing on the sample image according to the low-level feature, and obtain an association point of the target point based on a segmentation result.

In some implementations, the model training module 408 is specifically configured to: perform a first training on the initial neural network model based on the initial label and the extended label, and determine the neural network model that reaches a first training end condition as a first neural network model; obtain an output result of the first neural network model for each to-be-measured point in the sample image, and generate a pseudo label based on the output result, the pseudo label including a semantic category and an instance category to which each of the to-be-measured points in the sample image belongs; perform a second training on the first neural network model based on the pseudo label, and determine the first neural network model that reaches a second training end condition as an instance segmentation model.

In some implementations, the output result includes an instance feature value, a semantic probability, and an offset vector; and the model training module 408 is specifically configured to: generate a pseudo label using a predetermined clustering algorithm based on the instance feature value, the semantic probability, and the offset vector of each of to-be-measured points in the sample image and the semantic category and the instance category to which the target point belongs.

In some implementations, the model training module 408 is specifically configured to: by taking the target point as an initial cluster center in a predetermined clustering algorithm, perform a clustering processing based on the initial cluster center and the instance feature value, the semantic probability and the offset vector of each of the to-be-measured points in the sample image; and obtain a semantic category and an instance category to which each of the to-be-measured points in the sample image belongs based on the clustering result and the semantic category and the instance category to which the target point belongs.

In some embodiments, the model training module 408 is specifically configured to: during an initial clustering process, obtain a first similarity between each of the to-be-measured points and the initial cluster center based on the instance feature value, the semantic probability and the offset vector of each of the to-be-measured points in the sample image, and determine a new cluster center according to the first similarity; and during a non-initial clustering process, obtain a second similarity between each of the to-be-measured points and a cluster center obtained by a previous clustering processing based on the instance feature value, the semantic probability and the offset vector of each of the to-be-measured points in the sample image, and determine a new cluster center according to the second similarity until the cluster center does not change any more.

In some implementations, the model training module 408 is specifically configured to: obtain, according to a clustering result, a cluster point of the target point, where the cluster point is a to-be-measured point in the sample image that belongs to a same cluster as the target point, and a cluster in the clustering result is in a one-to-one correspondence with an object in the sample image; and determine the semantic category and the instance category to which the target point belongs as the semantic category and the instance category of the cluster point, respectively.

The apparatus for model training provided by embodiments of the present disclosure may perform the model training method provided by any embodiment of the present disclosure, and has functional modules and beneficial effects corresponding to the execution method.

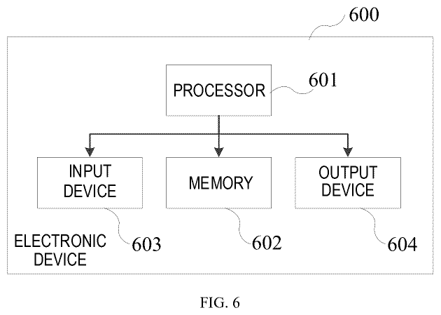

Corresponding to the foregoing instance segmentation method, FIG. 5 is a schematic structural diagram of an instance segmentation apparatus according to an embodiment of the present disclosure. The apparatus may be implemented in software and/or hardware which is generally integrated in the electronic device. As shown in FIG. 5, the method includes:
an image obtaining module 502 configured to obtain a target image.
a model input module 504 configured to input the target image into a pre-trained instance segmentation model, where the instance segmentation model is obtained by using any of the model training methods described above;
a result obtaining module 506 configured to obtain an instance segmentation result output from the instance segmentation model, where the instance segmentation result comprises a semantic category and an instance category to which each point in the target image belongs.

Because the labeling cost required by the instance segmentation model used by the instance segmentation device is relatively low, that is, obtaining the instance segmentation model is more convenient, the universality of the instance segmentation method is also improved.

The apparatus for instance segmentation provided in embodiments of the present disclosure may perform the instance segmentation method provided by any embodiment of the present disclosure, and has functional modules and beneficial effects corresponding to the execution method.

A person skilled in the art may clearly understand that, for the convenience and brevity of description, the specific working process of the device embodiments described above may refer to the corresponding processes in the method embodiments, and details are not described herein again.

Embodiment of the present disclosure provide an electronic device, including: a processor; a memory configured to store processor-executable instructions; and a processor configured to read the executable instructions from the memory and execute the instructions to implement any one of the foregoing model training methods or the instance segmentation methods.

FIG. 6 is a schematic structural diagram of an electronic device according to an embodiment of the present disclosure. As shown in FIG. 6, the electronic device 600 includes one or more processors 601 and a memory 602.

The processor 601 may be a central processing unit (CPU) or other form of processing unit having data processing capabilities and/or instruction execution capabilities and may control other components in the electronic device 600 to perform desired functions.

The memory 602 may include one or more computer program products, and the computer program product may include various forms of computer-readable storage media, such as volatile memory and/or non-volatile memory. The volatile memory may include, for example, random access memory (RAM) and/or cache memory. The non-volatile memory may include, for example, a read-only memory (ROM), a hard disk, a flash memory, or the like. The computer readable storage medium may store one or more computer program instructions, and the processor 601 may run the program instructions to implement the model training method or the instance segmentation method and/or other desired functions of the embodiments of the present disclosure described above. Various content such as input signals, signal components, noise components, and the like may also be stored in the computer-readable storage medium.

In one example, the electronic device 600 may further include an input device 603 and an output device 604, and these components are interconnected by a bus system and/or another form of connection mechanism (not shown).

In addition, the input device 603 may further include, for example, a keyboard, a mouse, and the like.

The output apparatus 604 may output various information to the outside, including determined distance information, direction information, and the like. The output device 604 may include, for example, a display, a speaker, a printer, and a communication network and their connected remote output devices, among others.

Of course, for simplicity, only some of the components related to the present disclosure in the electronic device 600 are shown in FIG. 6, and components such as a bus, an input/output interface and the like are omitted. In addition, according to a specific application situation, the electronic device 600 may further include any other suitable components.

In addition to the foregoing method and apparatus, an embodiment of the present disclosure may further be a computer program product, including computer program instructions that, when executed by a processor, cause the processor to perform the model training method or the instance segmentation method provided in the embodiments of the present disclosure.

The computer program product may be written in any combination of one or more programming languages, including an object-oriented programming language, such as Java, C ++, or the like, and also including a conventional procedural programming language, such as a “C” language or similar programming language. The program code may execute entirely on a user computing device, partially on a user device, as a stand-alone software package, partially on a user computing device, partially on a remote computing device, or entirely on a remote computing device or server.

In addition, the embodiments of the present disclosure may further be a computer-readable storage medium having stored thereon computer program instructions that, when executed by a processor, cause the processor to perform the model training method or the instance segmentation method provided by the embodiments of the present disclosure.

The computer-readable storage medium may employ any combination of one or more readable media. The readable medium may be a readable signal medium or a readable storage medium. The readable storage medium may include, but is not limited to, an electric, magnetic, optical, electromagnetic, infrared, or semiconductor system, device, or device, or any combination thereof. More specific examples (non-exhaustive list) of the readable storage medium include: an electrical connection having one or more wires, a portable disk, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

An embodiment of the present disclosure further provides a computer program product, including a computer program/instruction, where the computer program/instruction, when executed by a processor, implements the model training method or the instance segmentation method in the embodiments of the present disclosure.

It should be noted that, in this specification, relational terms such as “first” and “second” are merely used to distinguish one entity or operation from another entity or operation, and do not necessarily require or imply that any such actual relationship or sequence exists between these entities or operations. Moreover, the terms “including,” “comprising,” or any other variation thereof are intended to cover a non-exclusive inclusion, such that a process, method, article, or apparatus comprising a series of elements includes not only those elements, but also other elements not expressly listed, or elements inherent to such a process, method, article, or apparatus. Without further restriction, the elements defined by the statement “include one” do not preclude the presence of additional identical elements in the process, method, article, or device that includes the elements.

The above descriptions are only specific embodiments of the present disclosure, so that those skilled in the art can understand or implement the present disclosure. Various modifications to these embodiments will be apparent to those skilled in the art, the general principles definition herein may be implemented in other embodiments without departing from the spirit or scope of the present disclosure. Accordingly, the present disclosure will not be limited to these embodiments described herein but is to be accorded the widest scope consistent with the principles and novel features disclosed herein.

1-13. (canceled)

14. A model training method, comprising:
obtaining a sample image;
obtaining an initial label of the sample image, wherein the initial label comprises a semantic category and an instance category to which a target point belongs, each object in the sample image is labeled with one target point, and the target point labeled by the object is a point in the object;
generating an extended label of the sample image based on the initial label, wherein the extended label comprises a semantic category and an instance category to which an association point of the target point belongs, and the semantic category and the instance category to which the association point belongs are determined based on a semantic category and an instance category to which the target point belongs; and
training an initial neural network model based on the initial label and the extended label, and determining the neural network model at the end of the training as an instance segmentation model.

15. The method of claim 14, wherein generating the extended label of the sample image based on the initial label comprises:
obtaining a low-level feature of the sample image;
performing a segmentation processing on the sample image according to the low-level feature, and obtaining the association point of the target point based on a segmentation result; and
obtaining the extended label of the sample image by determining the semantic category and the instance category to which the target point belongs as the semantic category and the instance category to which the association point belongs to.

16. The method of claim 15, wherein performing the segmentation processing on the sample image according to the low-level feature, and obtaining the association point of the target point based on the segmentation result comprises at least one of the following:
in response to that the sample image is a two-dimensional image, performing a superpixel segmentation processing on the sample image according to the low-level feature, and obtaining an association point of the target point based on a segmentation result; and
in response to that the sample image is a three-dimensional image, performing a supervoxel segmentation processing on the sample image according to the low-level feature, and obtaining an association point of the target point based on a segmentation result.

17. The method of claim 14, wherein training a preset neural network model based on the initial label and the extended label, and taking the neural network model at the end of the training as the instance segmentation model comprises:
performing a first training on the initial neural network model based on the initial label and the extended label, and determining the neural network model that reaches a first training end condition as a first neural network model;
obtaining an output result of the first neural network model for each to-be-measured point in the sample image, and generating a pseudo label based on the output result, the pseudo label comprising a semantic category and an instance category to which each of the to-be-measured points in the sample image belongs; and
performing a second training on the first neural network model based on the pseudo label, and determining the first neural network model that reaches a second training end condition as an instance segmentation model.

18. The method of claim 17, wherein the output result comprises an instance feature value, a semantic probability and an offset vector; and a step of generating the pseudo label based on the output result comprises:
generating a pseudo label using a predetermined clustering algorithm based on the instance feature value, the semantic probability, and the offset vector of each of to-be-measured points in the sample image and the semantic category and the instance category to which the target point belongs.

19. The method of claim 18, wherein a step of generating the pseudo label using the predetermined clustering algorithm comprises:
by taking the target point as an initial cluster center in a predetermined clustering algorithm, performing a clustering processing based on the initial cluster center and the instance feature value, the semantic probability and the offset vector of each of the to-be-measured points in the sample image; and
obtaining a semantic category and an instance category to which each of the to-be-measured points in the sample image belongs based on the clustering result and the semantic category and the instance category to which the target point belongs.

20. The method of claim 19, wherein performing the clustering processing based on the initial cluster center and the instance feature value, the semantic probability and the offset vector of each of the to-be-measured points in the sample image comprises:
during an initial clustering process, obtaining a first similarity between each of the to-be-measured points and the initial cluster center based on the instance feature value, the semantic probability and the offset vector of each of the to-be-measured points in the sample image, and determining a new cluster center according to the first similarity; and
during a non-initial clustering process, obtaining a second similarity between each of the to-be-measured points and a cluster center obtained by a previous clustering processing based on the instance feature value, the semantic probability and the offset vector of each of the to-be-measured points in the sample image, and determining a new cluster center according to the second similarity until the cluster center does not change any more.

21. The method of claim 19, wherein the obtaining a semantic category and an instance category to which each of the to-be-measured points belongs in the sample image according to a clustering result and the semantic category and the instance category to which the target point belongs comprises:
obtaining, according to a clustering result, a cluster point of the target point, wherein the cluster point is a to-be-measured point in the sample image that belongs to a same cluster as the target point, and a cluster in the clustering result is in a one-to-one correspondence with an object in the sample image; and
determining the semantic category and the instance category to which the target point belongs as the semantic category and the instance category of the cluster point, respectively.

22. A method for instance segmentation, comprising:
obtaining a target image;
inputting the target image into a pre-trained instance segmentation model, wherein the instance segmentation model is obtained by using a model training method; and
obtaining an instance segmentation result output from the instance segmentation model, wherein the instance segmentation result comprises a semantic category and an instance category to which each point in the target image belongs, and
wherein the model training method comprises:.
obtaining a sample image;
obtaining an initial label of the sample image, wherein the initial label comprises a semantic category and an instance category to which a target point belongs, each object in the sample image is labeled with one target point, and the target point labeled by the object is a point in the object;
generating an extended label of the sample image based on the initial label, wherein the extended label comprises a semantic category and an instance category to which an association point of the target point belongs, and the semantic category and the instance category to which the association point belongs are determined based on a semantic category and an instance category to which the target point belongs; and
training an initial neural network model based on the initial label and the extended label, and determining the neural network model at the end of the training as an instance segmentation model.

23. The method of claim 22, wherein generating the extended label of the sample image based on the initial label comprises:
obtaining a low-level feature of the sample image;
performing a segmentation processing on the sample image according to the low-level feature, and obtaining the association point of the target point based on a segmentation result; and
obtaining the extended label of the sample image by determining the semantic category and the instance category to which the target point belongs as the semantic category and the instance category to which the association point belongs to.

24. The method of claim 23, wherein performing the segmentation processing on the sample image according to the low-level feature, and obtaining the association point of the target point based on the segmentation result comprises at least one of the following:
in response to that the sample image is a two-dimensional image, performing a superpixel segmentation processing on the sample image according to the low-level feature, and obtaining an association point of the target point based on a segmentation result; and
in response to that the sample image is a three-dimensional image, performing a supervoxel segmentation processing on the sample image according to the low-level feature, and obtaining an association point of the target point based on a segmentation result.

25. The method of claim 22, wherein training a preset neural network model based on the initial label and the extended label, and taking the neural network model at the end of the training as the instance segmentation model comprises:
performing a first training on the initial neural network model based on the initial label and the extended label, and determining the neural network model that reaches a first training end condition as a first neural network model;
obtaining an output result of the first neural network model for each to-be-measured point in the sample image, and generating a pseudo label based on the output result, the pseudo label comprising a semantic category and an instance category to which each of the to-be-measured points in the sample image belongs; and
performing a second training on the first neural network model based on the pseudo label, and determining the first neural network model that reaches a second training end condition as an instance segmentation model.

26. The method of claim 25, wherein the output result comprises an instance feature value, a semantic probability and an offset vector; and a step of generating the pseudo label based on the output result comprises:
generating a pseudo label using a predetermined clustering algorithm based on the instance feature value, the semantic probability, and the offset vector of each of to-be-measured points in the sample image and the semantic category and the instance category to which the target point belongs.

27. The method of claim 26, wherein a step of generating the pseudo label using the predetermined clustering algorithm comprises:
by taking the target point as an initial cluster center in a predetermined clustering algorithm, performing a clustering processing based on the initial cluster center and the instance feature value, the semantic probability and the offset vector of each of the to-be-measured points in the sample image; and
obtaining a semantic category and an instance category to which each of the to-be-measured points in the sample image belongs based on the clustering result and the semantic category and the instance category to which the target point belongs.

28. The method of claim 27, wherein performing the clustering processing based on the initial cluster center and the instance feature value, the semantic probability and the offset vector of each of the to-be-measured points in the sample image comprises:
during an initial clustering process, obtaining a first similarity between each of the to-be-measured points and the initial cluster center based on the instance feature value, the semantic probability and the offset vector of each of the to-be-measured points in the sample image, and determining a new cluster center according to the first similarity; and
during a non-initial clustering process, obtaining a second similarity between each of the to-be-measured points and a cluster center obtained by a previous clustering processing based on the instance feature value, the semantic probability and the offset vector of each of the to-be-measured points in the sample image, and determining a new cluster center according to the second similarity until the cluster center does not change any more.

29. The method of claim 27, wherein the obtaining a semantic category and an instance category to which each of the to-be-measured points belongs in the sample image according to a clustering result and the semantic category and the instance category to which the target point belongs comprises:
obtaining, according to a clustering result, a cluster point of the target point, wherein the cluster point is a to-be-measured point in the sample image that belongs to a same cluster as the target point, and a cluster in the clustering result is in a one-to-one correspondence with an object in the sample image; and
determining the semantic category and the instance category to which the target point belongs as the semantic category and the instance category of the cluster point, respectively.

30. An electronic device, comprising:
a processor;
a memory for storing executable instructions by the processor;
the processor is configured to read the executable instruction from the memory and executes the executable instructions to implement a model training method, comprising:
obtaining a sample image;
obtaining an initial label of the sample image, wherein the initial label comprises a semantic category and an instance category to which a target point belongs, each object in the sample image is labeled with one target point, and the target point labeled by the object is a point in the object;
generating an extended label of the sample image based on the initial label, wherein the extended label comprises a semantic category and an instance category to which an association point of the target point belongs, and the semantic category and the instance category to which the association point belongs are determined based on a semantic category and an instance category to which the target point belongs; and
training an initial neural network model based on the initial label and the extended label, and determining the neural network model at the end of the training as an instance segmentation model.

31. The electronic device of claim 30, wherein generating the extended label of the sample image based on the initial label comprises:
obtaining a low-level feature of the sample image;
performing a segmentation processing on the sample image according to the low-level feature, and obtaining the association point of the target point based on a segmentation result; and
obtaining the extended label of the sample image by determining the semantic category and the instance category to which the target point belongs as the semantic category and the instance category to which the association point belongs to.

32. The electronic device of claim 31, wherein performing the segmentation processing on the sample image according to the low-level feature, and obtaining the association point of the target point based on the segmentation result comprises at least one of the following:
in response to that the sample image is a two-dimensional image, performing a superpixel segmentation processing on the sample image according to the low-level feature, and obtaining an association point of the target point based on a segmentation result; and
in response to that the sample image is a three-dimensional image, performing a supervoxel segmentation processing on the sample image according to the low-level feature, and obtaining an association point of the target point based on a segmentation result.

33. The electronic device of claim 30, wherein training a preset neural network model based on the initial label and the extended label, and taking the neural network model at the end of the training as the instance segmentation model comprises:
performing a first training on the initial neural network model based on the initial label and the extended label, and determining the neural network model that reaches a first training end condition as a first neural network model;
obtaining an output result of the first neural network model for each to-be-measured point in the sample image, and generating a pseudo label based on the output result, the pseudo label comprising a semantic category and an instance category to which each of the to-be-measured points in the sample image belongs; and
performing a second training on the first neural network model based on the pseudo label, and determining the first neural network model that reaches a second training end condition as an instance segmentation model.
